(19) United States
(12) Patent Application Publication
(10) Pub. No.: US 2024/0193478 A1
(43) Pub. Date: Jun. 13, 2024

(54) TRAINING DATA EVALUATION SYSTEM, METHOD, AND PROGRAM

(71) Applicant: Hitachi Solutions, Ltd., Tokyo (JP)

(72) Inventors: Yuxin LIANG, Tokyo (JP); Masashi EGI, Tokyo (JP); Koji NAKAYAMA, Tokyo (JP)

(73) Assignee: Hitachi Solutions, Ltd., Tokyo (JP)

(21) Appl. No.: 18/446,909

(22) Filed: Aug. 9, 2023

(30) Foreign Application Priority Data
Dec. 8, 2022 (JP) 2022-196152

(51) Int. Cl. G06N 20/00

(52) U.S. Cl. CPC G06N 20/00

(57) ABSTRACT

It is possible to effectively and efficiently add training data. A training data evaluation system includes an uncertainty calculation unit configured to calculate, based on a prediction value obtained from a machine learning model using evaluation data for evaluating a shortage of training data as an input and a correct answer for the evaluation data, a data shortage degree representing a training data shortage degree for each piece of the evaluation data; a target selection unit configured to extract target data, which is data to be added to the training data, based on a predetermined selection rule and the data shortage degree; and a tendency analysis planning unit configured to specify a tendency of the target data based on a predetermined analysis rule and specify a property of the training data to be added based on the tendency of the target data.

### BACKGROUND OF THE INVENTION

### 1. Field of the Invention

The present disclosure relates to a training data evaluation system, a training data evaluation method, and a training data evaluation program for machine learning.

### 2. Description of Related Art

In a prediction model constructed by performing training on training data, prediction accuracy decreases in a training data shortage area. Therefore, it is important to evaluate the training data and to add training data when the training data is shortage to ensure the prediction accuracy of the prediction model.

There is a method of inputting an image into a prediction model for image identification or region identification, and calculating a training data shortage degree for that image from output fluctuation obtained from the prediction model (PTL 1 and NPL 1). In the method, the training data shortage degree is calculated for each image. The training data shortage degree is a high value for an image including an image feature that is shortage in the training data.

As described in PTL 2, there is a method of automatically creating an image to be added to training data by giving image feature information and position information by a human. As described in PTL 3, there is a method of clustering training data to extract image data having a relatively small number of cases and visualizing the information.

### CITATION LIST

### Patent Literature

PTL 1: JP2022-521957A
PTL 2: WO2021/193347A1
PTL 3: JP2020-522055A

### Non-Patent Literature

NPL 1: A, Kendall, et al “What uncertainties do we need in Bayesian deep learning for computer vision?” arXiv:1703.04977.

### SUMMARY OF THE INVENTION

Even though a training data shortage degree is known for each image, it is unknown what kind of factor is causing the shortage degree or what kind of image should be created as an image to be added to the training data from images having a high shortage degree. After all, an expert makes a human judgment based on an image and the like as to what kind of image should be added from the images having a high training data shortage degree, which is inefficient.

An object of the present disclosure is to provide a technique capable of effectively and efficiently adding the training data.

A training data evaluation system according to an aspect of the present invention includes an uncertainty calculation unit configured to calculate, based on a prediction value obtained from a machine learning model using evaluation data for evaluating a shortage of training data as an input and a correct answer for the evaluation data, a data shortage degree representing a training data shortage degree for each piece of the evaluation data; a target selection unit configured to extract target data, which is data to be added to the training data, based on a predetermined selection rule and the data shortage degree; and a tendency analysis planning unit configured to specify a tendency of the target data based on a predetermined analysis rule and specify a property of the training data to be added based on the tendency of the target data.

The invention can provide a training data evaluation system, a training data evaluation method, and a training data evaluation program which make it possible to effectively and efficiently add training data.

### BRIEF DESCRIPTION OF THE DRAWINGS

FIG. 1 is a functional block diagram illustrating a configuration example of a training data evaluation system;

FIG. 2 is a conceptual diagram illustrating a format of training data;

FIG. 3 is a conceptual diagram illustrating a format of evaluation data;

FIG. 4 is a conceptual diagram illustrating a structure of a machine learning model;

FIG. 5 is a conceptual diagram illustrating a format of determination data;

FIG. 6 is a conceptual diagram illustrating a format of uncertainty data;

FIG. 7 is a conceptual diagram illustrating a format of a selection rule;

FIG. 8 is a conceptual diagram illustrating a format of an analysis rule;

FIG. 9 is a conceptual diagram illustrating a format of improvement proposal data after being filled up;

FIG. 10 is a flowchart illustrating uncertainty calculation processing;

FIG. 11 is a flowchart illustrating target selection processing;

FIG. 12 is a flowchart illustrating tendency analysis planning processing;

FIG. 13 is a conceptual diagram illustrating a format of the uncertainty data;

FIG. 14 is a conceptual diagram illustrating a selection result according to a target selection unit;

FIG. 15 is a diagram illustrating a display example on a display unit;

FIG. 16 is a diagram illustrating a display example on the display unit;

FIG. 17 is a conceptual diagram illustrating a format of the determination data;

FIG. 18 is a conceptual diagram illustrating a format of the uncertainty data;

FIG. 19 is a flowchart illustrating correct answer prediction identification processing;

FIG. 20 is a diagram illustrating a display example on the display unit; and

FIG. 21 is a diagram illustrating a display example on the display unit.

### DESCRIPTION OF EMBODIMENTS

Hereinafter, embodiments of the invention will be described with reference to the drawings.

### Embodiment 1

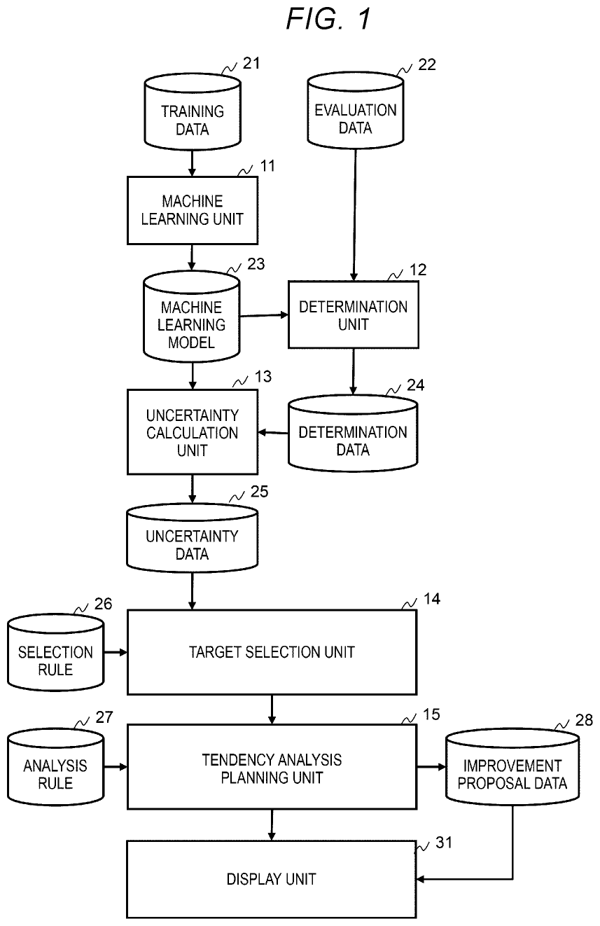

FIG. 1 is a functional block diagram illustrating a configuration example of a training data evaluation system.

A training data evaluation system 1 includes at least a processing device and a storage device that are not illustrated. The training data evaluation system 1 may further include a communication device, an input device, an output device, and the like.

The processing device includes, for example, a central processing unit (CPU), a micro processing unit (MPU), a graphics processing unit (GPU), and a field-programmable gate array (FPGA). Various functions of the training data evaluation system 1 are implemented by the processing device reading and executing various programs and various pieces of data stored in the storage device.

More specifically, the processing device implements a machine learning unit 11, a determination unit 12, an uncertainty calculation unit 13, a target selection unit 14, and a tendency analysis planning unit 15 by reading and executing various programs and various pieces of data stored in the storage device.

The storage device is a device that stores programs and data, and is, for example, a random access memory (RAM), a read only memory (ROM), or a non-volatile RAM (NVRAM).

The storage device may be, for example, a reading and writing device of a recording medium such as a hard disc drive (HDD), a solid state drive (SSD), a storage system, an integrated circuit (IC) card, a secure digital (SD) memory card, and an optical recording medium (compact disc (CD), digital versatile disc (DVD), or the like), or a storage region of a cloud server.

The storage device may be a combination of a plurality of the above various storage devices.

Various programs and data are stored in the storage device. Specifically, training data 21, evaluation data 22, a machine learning model 23, determination data 24, uncertainty data 25, a selection rule 26, an analysis rule 27, and improvement proposal data 28 are stored in the storage device.

The communication device is a wired or wireless communication interface that implements communication with another device via a communication unit such as a local area network (LAN) or the Internet, and is, for example, a network interface card (NIC), a wireless communication module, a universal serial interface (USB) module, or a serial communication module.

The input device is a device that receives an input from a user. The input device is, for example, a keyboard, a mouse, a touch panel, a card reader, or a voice input device.

The output device is a device that provides various kinds of information such as a processing progress and a processing result to the user. The output device is, for example, a screen display device (liquid crystal display (LCD) head mounted display (HMD), or the like), an audio output device, or a printing device. The training data evaluation system 1 may be configured to input and output information to and from another device via the communication device.

Next, an outline of data processing performed by the training data evaluation system 1 will be described with reference to FIG. 1.

The machine learning unit 11 performs machine learning using the training data 21 which is input data. A type of the machine learning is not particularly limited. As a result of the machine learning, the trained machine learning model 23 is constructed. In embodiment 1, the machine learning model 23 is a model obtained by the machine learning. An example of the machine learning model 23 includes an object detection model, that is, a model for detecting a predetermined object from an image. However, a problem that can be applied to the training data evaluation system 1 is not limited to object detection, and the machine learning model 23 may be a model other than the object detection model, for example, a model applied to other types of problems such as area division, classification, and regression.

The determination unit 12 outputs the determination data 24 by inputting the evaluation data 22 to the constructed machine learning model 23. The determination data 24 includes a prediction value obtained from the machine learning model 23.

The uncertainty calculation unit 13 generates uncertainty data based on the machine learning model 23 and the determination data 24. The generated uncertainty data 25 is stored in the storage device.

The target selection unit 14 extracts target data based on the predetermined and stored selection rule 26 and the uncertainty data 25. The extraction mentioned herein includes classifying the data into a plurality of clusters. In practice, the extraction may be interpreted as being classified into two clusters of a cluster to be extracted and a cluster not to be extracted.

That is, the target selection unit 14 extracts the target data which is data to be added to the training data based on the predetermined selection rule and a data shortage degree in the uncertainty data 25.

More specifically, the target selection unit 14 extracts the target data based on the selection rule and a fluctuation value.

The tendency analysis planning unit 15 analyzes each target data based on the predetermined and stored analysis rule 27 and generates the improvement proposal data 28. More specifically, the tendency analysis planning unit 15 specifies a tendency of the target data based on the predetermined analysis rule 27, and specifies a property of the training data to be added based on the tendency of the target data. The tendency mentioned here means a tendency such that the data is shortage. The property of the training data may be, for example, a property corresponding to a tendency determination condition in the analysis rule 27, such that a color variance of an object is 0.3 or more.

A display unit 31 displays a tendency analysis result by the tendency analysis planning unit 15. The display unit 31 may display the tendency analysis result and data based on the improvement proposal data 28 together.

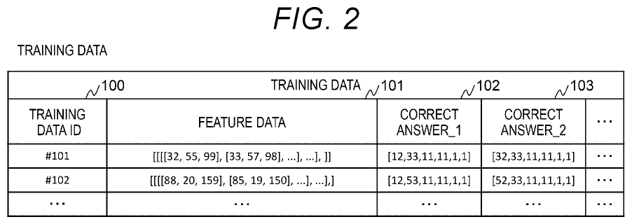

FIG. 2 is a conceptual diagram illustrating a format of the training data 21.

FIG. 2 illustrates an example of the format of the training data when solving the object detection. However, the problem that can be applied to the training data evaluation system 1 is not limited to the object detection, and may be other types of problems such as the area division, the classification, and the regression.

A training data ID 100 is an ID uniquely assigned to the data.

Feature data 101 is information indicating a feature of the training data. In a case of the object detection, a multi-dimensional array indicating an input image is obtained.

Correct answers 102 and 103 each include, for example, position information of an object, a likelihood that the object exists, and class information of the object in the object detection. The number of correct answer_1, correct answer_2, and so on corresponds to the number of detected objects. For example, when there are two detected objects, the correct answers are the correct answer 1 and the correct answer 2. Each correct answer includes values such as object position information, a likelihood, and class information. For example, in identification, the correct answer is information for each class to be identified. The number of correct answer 1, correct answer 2, and so on corresponds to the number of classes to be identified. For example, when the number of classes is 3, the correct answers are correct answer 1, correct answer 2, and correct answer 3. In a case of the regression, the number of classes to be identified is only one.

A form of the correct answer varies according to a type of a target problem. For example, in the case of the object detection illustrated in FIG. 2, the form of the correct answer is expressed by each rectangle [x, y, w, h, cls, obj]. A letter x represents an X coordinate of a rectangular frame, a letter y represents a Y coordinate of the rectangular frame, a letter w represents a width of the rectangular frame, a letter h represents a height of the rectangular frame, cls represents a class, and obj is a value indicating a likelihood of whether the target object exists within the rectangular frame. In the case of the identification, a likelihood to classify into a class associated with each correct answer is expressed by one-dimensional information. In other types of problems, a format of correct answer data generally used by a skilled in the art may be used.

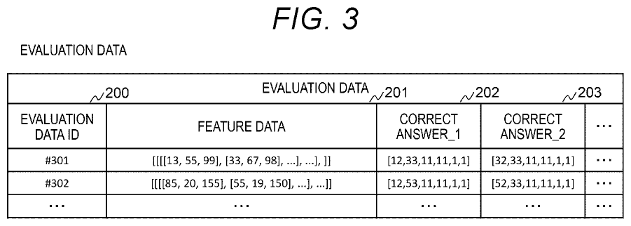

FIG. 3 is a conceptual diagram illustrating a format of the evaluation data 22. The evaluation data 22 is used to evaluate a shortage of the training data.

Formats of an evaluation data ID 200, feature data 201, and correct answers 202 and 203 in the evaluation data 22 are the same as those of the training data ID 100, the feature data 101, the correct answers 102 and 103 in the training data 21, and thus a detailed description thereof will be omitted.

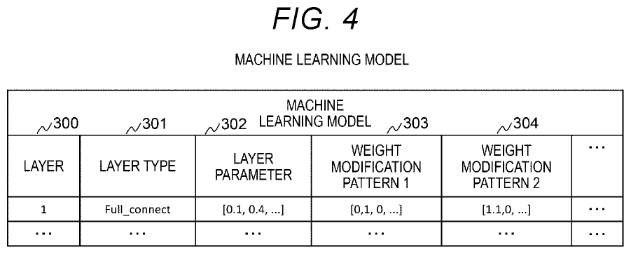

FIG. 4 is a conceptual diagram illustrating a structure of the machine learning model 23.

A layer 300 means a layer number in the machine learning model 23. A layer type 301 means, for example, a type of a layer such as a fully connected layer or a convolutional layer. A layer parameter 302 means a parameter for the layer, that is, a value of weight of each layer. The layer parameters exist as many as the number of layers in the neural network, and each layer parameter has the number of dimensions for the number of nodes in the layer.

Weight modification patterns 303 and 304 mean modified patterns when weight of each node is modified in a layer in the neural network. A method of modifying the weight of the node includes a method of changing a value of the weight, a method of causing the node itself to be lost (dropout), and the like. The dropout can be expressed by setting the weight of the node or a value of a bias to 0. In one layer, the number of modified patterns may be one or two or more. A weight modification pattern has the same number of dimensions as the layer parameters. The weight modification pattern is expressed by, for example, a node to be lost by the dropout=0 and a maintaining node that is not lost=1.

In the embodiment according to the present disclosure, each layer in the machine learning model 23 is modified by the dropout, and a fluctuation of an output value according to the modification is measured. A value indicating the fluctuation, that is, the fluctuation value, is calculated as the data shortage degree in the uncertainty data by the uncertainty calculation unit 13.

That is, the uncertainty calculation unit 13 calculates a data shortage degree representing the training data shortage degree for each piece of evaluation data based on the prediction value obtained from the machine learning model 23 and the correct answer to the evaluation data. The data shortage degree includes a fluctuation value representing the degree of fluctuation in the prediction value when the weight in the machine learning model 23 is modified.

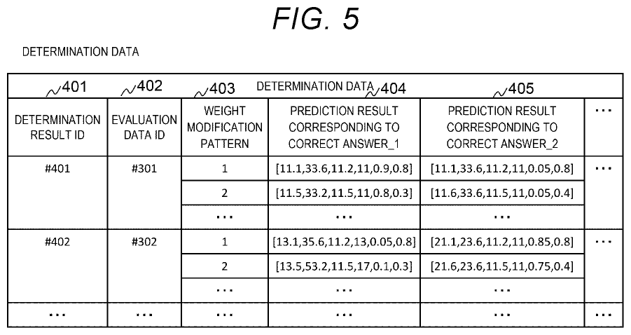

FIG. 5 is a conceptual diagram illustrating a format of the determination data 24.

A determination result ID 401 is identification information uniquely indicating a determination result. An evaluation data ID 402 is identification information uniquely indicating the evaluation data. A weight modification pattern 403 means a weight modification pattern described with reference to FIG. 4.

Prediction results 404 and 405 corresponding to the correct answers are prediction values obtained by the determination unit 12 inputting the evaluation data 22 to the machine learning model 23. In the object detection, when there is one detected object, a prediction result for the detected object is in the determination data 24. When there are two detected objects, the prediction result corresponding to each detected object is in the determination data 24. In the identification, when there are two classes to be identified, a prediction result corresponding to a correct answer 1 and a prediction result corresponding to a correct answer 2 are in the determination data 24. When there are three classes to be identified, the prediction result corresponding to the correct answer 1, the prediction result corresponding to the correct answer 2, and a prediction result corresponding to a correct answer 3 are in the determination data 24. In other words, there are prediction results corresponding to the correct answers as many as the number of classes. As described above, the prediction value for each class of the machine learning model 23 has a fluctuation in accordance with each weight modification pattern (pattern with loss of dropout).

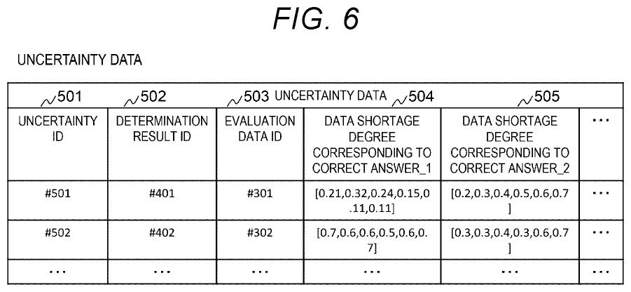

FIG. 6 is a conceptual diagram illustrating a format of the uncertainty data 25.

An uncertainty ID 501 is identification information uniquely indicating each piece of the uncertainty data. A determination result ID 502 and an evaluation data ID 503 are the same as the determination result ID 401 and the evaluation data ID 402 in FIG. 5, and thus a detailed description thereof will be omitted.

Data shortage degrees 504 and 505 corresponding to the correct answers are scores calculated by the uncertainty calculation unit 13 and exist as many as the number of the correct answers. For example, in the case of the object detection, the uncertainty calculation unit 13 calculates a score for each of six in [x, y, w, h, cls, obj] corresponding to each rectangle. In the case of the classification, the uncertainty calculation unit 13 calculates a score for each class (for example, three scores to be classified into three classes of rock, scissors, and paper). In the case of the regression, the number of classes is only one, and the uncertainty calculation unit 13 calculates only the score of the data shortage degree 504 corresponding to the correct answer_1. In this case, the correct answer_2 and thereafter are not originally provided.

The data shortage degree is a score indicating a variation in a prediction value obtained by a different weight modification pattern for each evaluation data. More specifically, the score may be a standard deviation, a variance, or the like.

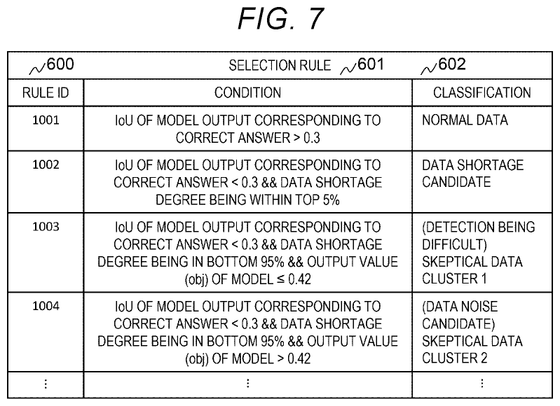

FIG. 7 is a conceptual diagram illustrating a format of the selection rule 26. The selection rule 26 is predetermined including a rule for classifying the target data based on the fluctuation value.

A rule ID 600 is identification information uniquely indicating the rule. A condition 601 is a condition for classifying target data in a classification 602 to be described later. The classification 602 is information indicating how data is classified.

A model output in the drawing means a prediction value output by the machine learning model 23. For example, when an IoU of the prediction value corresponding to the correct answer is greater than a predetermined threshold value, for example, 0.3, the target selection unit 14 classifies the data as normal data.

When the IoU of the prediction value corresponding to the correct answer is smaller than the predetermined threshold value, for example, 0.3, and the data shortage degree is within the top 5%, the target selection unit 14 classifies the data as a data shortage candidate and sets the data as the target data. In other words, it is considered that the prediction value deviates from the correct answer and the data is shortage.

The extraction of the target data based on the data shortage degree may be anything other than a criterion within the top 5%. That is, the selection rule 26 may be predetermined including a rule for setting the data, as the target data, in which the fluctuation value (data shortage degree) is in a predetermined ratio from an upper level.

When the IoU of the prediction value corresponding to the correct answer is smaller than the predetermined threshold value, for example, 0.3, the data shortage degree is in the bottom 95%, and the output value (obj) of the model is a predetermined value, for example, 0.42 or less, the target selection unit 14 classifies the data into a skeptical data cluster 1. In other words, since a probability that an object is included in the rectangle is low (the value of obj is small) it means that the data is classified as data for which the object detection is difficult.

When the IoU of the prediction value corresponding to the correct answer is smaller than the predetermined threshold value, for example, 0.3, the data shortage degree is in the bottom 95%, and the output value (obj) of the model is greater than the predetermined value, for example, 0.42, the target selection unit 14 classifies the data into a skeptical data cluster 2. In other words, although the probability that the object is included in the rectangle is high (the value of obj is small), there is a discrepancy between the prediction and the correct answer, and it cannot be said that there is a clear shortage of data, and thus it means that the data is classified as a data noise candidate.

A content of the condition 601 illustrated in FIG. 7 is an example of a preset condition in the case of the object detection. A different condition may be registered in the condition 601 in advance according to the type of the problem and a processing content to be performed using the machine learning. For example, in the case of the identification, a threshold value or a value for the fluctuation value (data shortage degree) may be determined to be the top 5%.

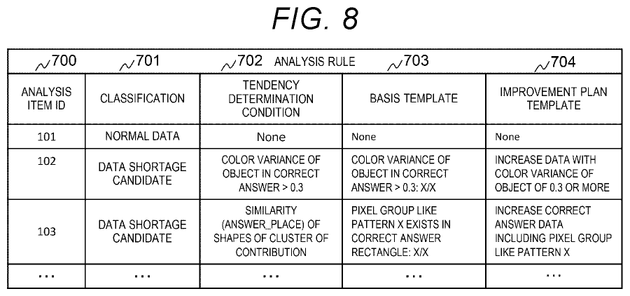

FIG. 8 is a conceptual diagram illustrating a format of the analysis rule 27.

An analysis item ID 700 is identification information uniquely indicating a data item to be analyzed.

Classification 701 means classification based on a tendency determination condition to be described later. It can be interpreted that determining whether the classification matches the tendency determination condition is to classify the target data having a common property specified by the tendency determination condition according to the tendency determination condition. That is, the analysis rule 27 is predetermined including a rule for classifying the target data into a plurality of classification groups according to the common property. In FIG. 8, the target data is classified into a group having an analysis item ID=102 and a group having an analysis item ID=103. In this case, the tendency analysis planning unit 15 classifies the target data into the classification groups based on the analysis rule 27, and specifies a property of the training data to be added for each classification group.

A tendency determination condition 702 is, for example, information indicating a determination condition (common property) when the target data is classified as the data shortage candidate. As an example, the tendency determination condition includes a case in which the color variance of the object in the correct answer is greater than 0.3, a value of similarity that means how similar shapes of clusters formed based on a contribution to be described later are, or the like.

The analysis rule 27 is predetermined including a rule for classifying the target data in which the color variance of the object in the correct answer is greater than a predetermined threshold value (for example, 0.3) into one classification group (group of the analysis item ID=102). In this case, the tendency analysis planning unit 15 may propose that an image having the color variance greater than the threshold value is to be generated based on the target data classified into the classification group and is to be added to the training data.

A basis template 703 and an improvement plan template 704 are templates of information to be displayed for the user via the display unit 31. “X” in the templates is a variable. The display unit 31 displays information in a state in which a value corresponding to a content of the data is filled up in a place of “X”. The filling up processing is performed by, for example, the tendency analysis planning unit 15. The data after being filled up may be stored as the improvement proposal data 28.

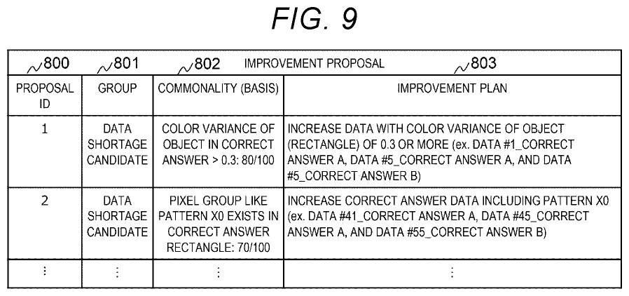

FIG. 9 is a conceptual diagram illustrating a format of the improvement proposal data 28 after being filled up. A plan ID 800 is identification information uniquely indicating a plan. A group 801 is a group corresponding to the classification 701 illustrated in FIG. 8. A commonality (basis) 802 and an improvement plan 803 are information after filling up the data in the basis template 703 and the improvement plan template 704 in FIG. 8, respectively. As illustrated in FIG. 9, the tendency analysis planning unit 15 may not only fill a value in the place of “X” of the template, but may also add information corresponding to a content of the improvement plan such as (ex. data #1_correct answer A, data #5_correct answer A, and data #5_correct answer B).

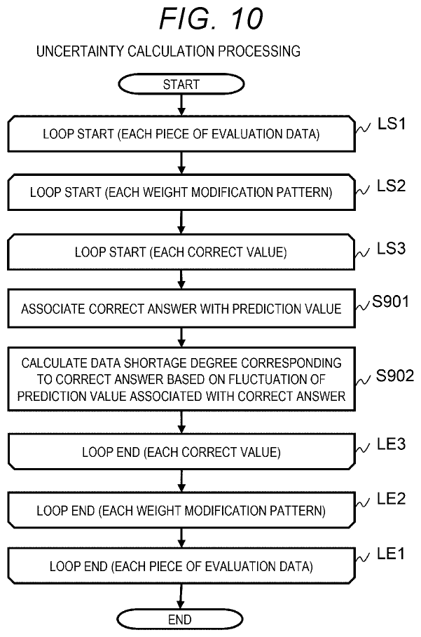

FIG. 10 is a flowchart illustrating uncertainty calculation processing.

The uncertainty calculation unit 13 performs uncertainty calculation processing. The uncertainty calculation unit 13 performs steps S901 and S902 for each piece of evaluation data, each weight modification pattern, and each correct value.

In step S901, the uncertainty calculation unit 13 associates a correct answer with a prediction value.

In step S902, the uncertainty calculation unit 13 calculates a data shortage degree corresponding to the correct answer based on a fluctuation of the prediction value associated with the correct answer.

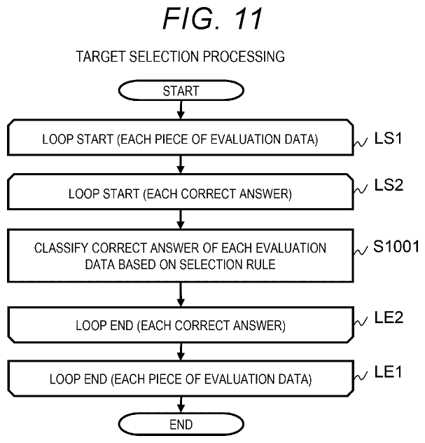

FIG. 11 is a flowchart illustrating target selection processing.

The target selection unit 14 performs the target selection processing. The target selection unit 14 performs step S1001 for each piece of evaluation data and each correct answer (such as correct answer_1 or correct answer_2).

In step S1001, the target selection unit 14 classifies the correct answer of each evaluation data based on the selection rule (see FIG. 8).

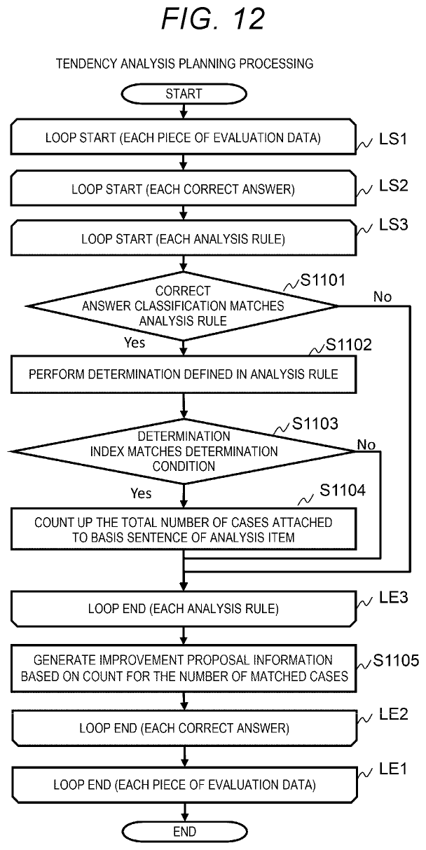

FIG. 12 is a flowchart illustrating tendency analysis planning processing.

The tendency analysis planning unit 15 performs processing after loop start LS2 for each evaluation data (loop start LS1). The tendency analysis planning unit 15 performs processing after loop start LS3 for each correct answer (loop start LS2). The tendency analysis planning unit 15 performs processing of steps S1101 to S1104 for each analysis rule (loop start LS3).

After a loop (LS3 to LE3) for each analysis rule is removed, the tendency analysis planning unit 15 performs processing of step S1105. When the loop (LS2 to LE2) for each correct answer and the loop (LS1 to LE1) for each evaluation data are removed, the tendency analysis planning processing ends.

In step S1101, the tendency analysis planning unit 15 determines whether the correct answer classification matches the analysis rule. If the correct classification matches the analysis rule (S1101: Yes), the processing proceeds to step S1102. If the correct classification does not match the analysis rule, the processing proceeds to the loop end LE3 for each analysis rule, and the processing of step S1101 for a next analysis rule is performed.

In step S1102, the tendency analysis planning unit 15 performs determination defined in the analysis rule. For example, when the analysis rule in the loop is the analysis rule for the analysis item ID=102 in FIG. 8, it is determined whether the color variance of the object in the correct answer is greater than 0.3. In this case, when the color variance of the object in the correct answer is greater than 0.3, the determination index matches the determination condition (tendency determination condition).

In step S1103, the tendency analysis planning unit 15 determines whether the determination index matches the determination condition (tendency determination condition). If the determination index matches the determination condition (S1103: Yes), the processing proceeds to step S1104. If the determination index does not match the determination condition, the processing proceeds to the loop end LE3 for each analysis rule, and the processing of step S1101 for the next analysis rule is performed.

In step S1104, the tendency analysis planning unit 15 counts up the total number of cases attached to a basis sentence of the matched analysis item. The basis sentence indicates the commonality (basis) 802 illustrated in FIG. 9. That is, in step S1104, values for a portion of “X/X”, which are values for filling in the basis template in FIG. 8, are counted up.

In step S1105, the tendency analysis planning unit 15 generates improvement proposal information based on the count for the number of the matched cases. That is, a value of the total number of the matched cases is filled up based on the basis template in FIG. 8 to complete the improvement proposal information for being displayed by the display unit 31.

### Embodiment 2

In Embodiment 1 described above, the data shortage degree is calculated as the uncertainty data, and the selection or the like based on the data shortage degree is performed. In Embodiment 2 described below, a data shortage contribution is calculated in addition to a data shortage degree. Embodiment 2 is an example in which the training data evaluation system 1 is applied to the identification. The machine learning model 23 in this case is a model for identifying what appears in an image.

When the training data evaluation system 1 is applied to the identification, the selection rule 26 may include a rule for setting evaluation data in which a fluctuation value is greater than a predetermined threshold value as target data. The analysis rule 27 in this case may include a rule for classifying target evaluation data into a target classification group based on a distribution of pixels in an image in which the data shortage contribution, which is a contribution to the fluctuation value (data shortage degree) of the pixels, is greater than a predetermined threshold value. The tendency analysis planning unit 15 may propose that an image having the distribution of the target classification group is to be generated from the target data classified into the target classification group based on the analysis rule 27 and is to be added to the training data. Proposing by the tendency analysis planning unit 15 means that information corresponding to a content of the proposal is generated and stored as the improvement proposal data 28.

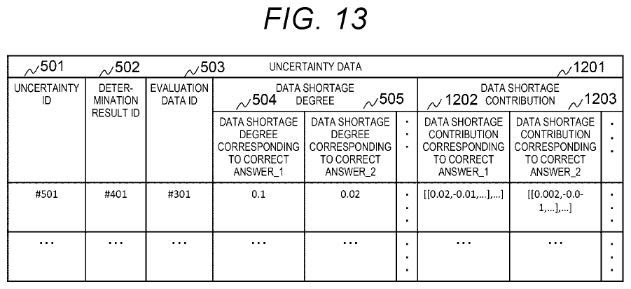

FIG. 13 is a conceptual diagram illustrating a format of the uncertainty data 25.

The uncertainty ID 501, the determination result ID 502, the evaluation data ID 503, and the data shortage degrees 504 and 505 corresponding to correct answers in FIG. 13 are the same as those in FIG. 6, and thus a detailed description thereof will be omitted.

In Embodiment 2, the uncertainty data 25 includes a data shortage contribution 1201. The uncertainty calculation unit 13 may calculate the data shortage contribution 1201. The data shortage contribution 1201 is calculated for each correct answer. In FIG. 13, as for the data shortage contribution, a data shortage contribution 1202 for correct answer 1 and a data shortage contribution 1203 for correct answer 2 are calculated, separately.

The data shortage contribution is a value indicating how much each element in the data influences the shortage of data (how much the element contributes). In the present specification, the data shortage contribution may be expressed as contribute.

The data shortage contribution “contribute” in the identification is, for example, a value calculated based on the following equation.

$$Contribute ( c , x , {x}^{′} ) = \frac{K - 1}{{K}^{2}} {\sum }_{k = 1}^{K} ( {IG}^{2} ( c , k , x , {x}^{′} ) - IG ( c , k , x , {x}^{′} ) * < IG ( c , k , x , {x}^{′} ) >$$

in which
x: input feature data
x′: reference feature data to be compared
K: the total number of weight modification patterns
M: the number of divisions in trapezoidal approximation of integral
p_{c,k} (x): prediction of class c for input feature data x in a model with a weight modification pattern k
∇ₓ p_{c,k} (x): partial differentiation of p_{c,k} (x) to pixel feature data x
p_{c,k}² (x): a predicted squared value of class c for the pixel feature data x in a weight modification pattern k model ∇ₓ p_{c,k}² (x): partial differentiation of p_{c,k}² (x) to the pixel feature data x

$$\begin{matrix}IG ( c , k , x , {x}^{′} ) = ( x - {x}^{′} ) {\int }_{0}^{1} {∇}_{x} {p}_{c , k} ( {x}^{′} + α ( x - {x}^{′} ) ) d α \\ \approx ( x - {x}^{′} ) \frac{{\sum }_{m = 1}^{M} {∇}_{x} {p}_{c , k} ( {x}^{′} + \frac{j}{M} ( x - {x}^{′} ) )}{M}\end{matrix} \\ \begin{matrix}IG ( c , k , x , {x}^{′} ) = ( x - {x}^{′} ) {\int }_{0}^{1} {∇}_{x} {p}_{c , k}^{2} ( {x}^{′} + α ( x - {x}^{′} ) ) d α \\ \approx ( x - {x}^{′} ) \frac{{\sum }_{m = 1}^{M} {∇}_{x} {p}_{c , k}^{2} ( {x}^{′} + \frac{j}{M} ( x - {x}^{′} ) )}{M}\end{matrix}$$

<IG(c, k, x, x′)>: an average value of IG(c, k, x, x′) obtained by a model “other than” the weight modification pattern k For example, when there are three weight modification patterns k (k=1, k=2, and k=3),

$$< IG ( c , k = 1 , x , {x}^{′} ) >= \frac{IG ( c , k = 2 , x , {x}^{′} ) + IG ( c , k = 3 , x , {x}^{′} )}{2}$$

The data shortage contribution “contribute” in the identification may be, for example, a value calculated based on the following equation.

$$Contribute ( c , x , {x}^{′} ) = ( x - {x}^{′} ) {\int }_{0}^{1} \frac{dv ( ( {x}^{′} + α ( x - {x}^{′} ) ) )}{dx} d α \approx ( x - {x}^{′} ) \frac{1}{K} {\sum }_{m = 1}^{M} \frac{dv ( {x}^{′} + \frac{m}{M} ( x - {x}^{′} ) )}{dx}$$

in which
x: input feature data
x′: reference feature data to be compared
K: the total number of weight modification patterns
M: the number of divisions in trapezoidal approximation of integral
p_{c,k} (x): prediction of class c for input feature data x in a model with a weight modification pattern k
v(x): a variance in prediction of p_{c,k} (x)

$$\frac{dv ( x )}{dx} :$$

a partial differentiation value of v(x) to x

$$v ( x ) = {\sum }_{k = 1}^{K} {p}_{c , k} {( x )}^{2} - \frac{1}{K} {( {\sum }_{k = 1}^{K} {p}_{c , k} ( x ) )}^{2} ;$$

$$\frac{dv ( x )}{dx} = {\sum }_{k = 1}^{K} 2 {p}_{c , k} ( x ) \frac{{dp}_{c , k} ( x )}{dx} - ( {\sum }_{k = 1}^{K} \frac{2}{{K}^{2}} {p}_{c , k} ( x ) ) * {\sum }_{k = 1}^{K} \frac{{dp}_{c , k} ( x )}{dx}$$

The training data evaluation system 1 may set a condition based on the data shortage contribution to the condition 601 in the selection rule 26. The training data evaluation system 1 may set a condition based on the data shortage contribution to the tendency determination condition 702 in the analysis rule 27.

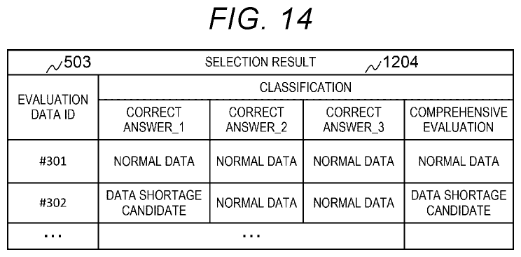

FIG. 14 is a conceptual diagram illustrating a selection result according to the target selection unit 14 in Embodiment 2.

The target selection unit 14 outputs a classification result for the correct answer of each evaluation data ID. For example, in evaluation data ID=#301, since the classifications of the correct answer_1, the correct answer_2, and the correct answer_3 are all “normal data”, a comprehensive evaluation is also classified as “normal data”. In evaluation data ID=#302, the classifications of the correct answer_2 and the correct answer_3 are “normal data”, but the classification of the correct answer_1 is a “data shortage candidate”, and thus the comprehensive evaluation is the “data shortage candidate”.

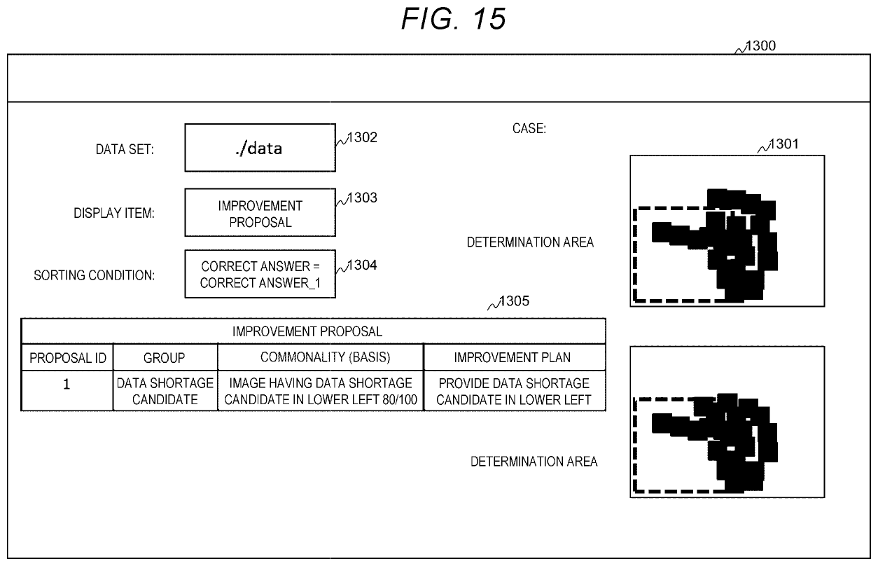

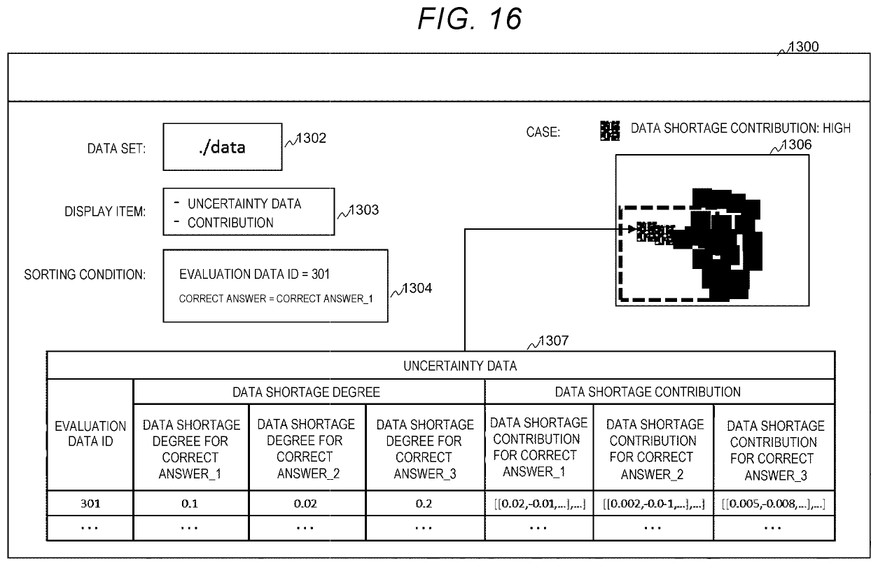

FIG. 15 is a diagram illustrating a display example on the display unit 31. FIG. 16 is a diagram illustrating a display example on the display unit 31.

The display unit 31 visualizes and displays information such as a list of improvement proposals, the number of cases, the cases, determination areas, and the like based on an analysis result obtained by the tendency analysis planning unit 15 and the improvement proposal data 28, and transmits the information to a user. Hereinafter, a content displayed on a display screen 1300 of the display unit 31 will be described.

In a display example of FIG. 15, a location (file path) of a data set is displayed on a data set 1302. A display item 1303 displays an improvement proposal, for example. A sorting condition 1304 displays a content indicating that the correct answer=correct answer_1. The sorting condition 1304 may mean a display condition indicating what a display target is, and may mean a sorting condition indicating based on which data the display target is to be sorted in ascending order or descending order.

In an improvement proposal 1305, the improvement proposal information stored in the improvement proposal data 28 is displayed. The display unit 31 displays the improvement proposal 1305 in which a property common to a target classification group set as the sorting condition, that is, a commonality (basis), and an improvement plan to be added with training data having an image based on the distribution of the target classification group are associated with each other. The distribution mentioned here means a distribution of pixels in the image in which the data shortage contribution, which is the contribution to the fluctuation value (data shortage degree) of the pixels, is greater than the predetermined threshold value.

In a case 1301, among the data selected by the target selection unit 14, data matching the sorting condition is displayed. In an example of FIG. 15, when solving the identification (the number of classes is 3) for identifying whether an input image obtained by imaging a hand is any of rock, scissors, and paper, data such that the correct answer is the rock (correct answer_1) is displayed as a case. In the case, the determination area for the data may be displayed in combination.

In an display example of FIG. 16, a detailed description of a part overlapping with FIG. 15 will be omitted. The display item 1303 displays the uncertainty data and the contribution. The sorting condition 1304 displays a content indicating that the evaluation data ID=301 and the correct answer=correct answer_1.

In an area in which the improvement proposal 1305 is displayed in FIG. 15, information 1307 of the uncertainty data and the contribution (data shortage contribution) that are the display targets are displayed in FIG. 16. In a case 1306, among the data selected by the target selection unit 14, data matching the sorting condition is displayed. In an example of FIG. 16, when solving the identification (the number of classes is 3) for identifying whether the input image obtained by imaging the hand is any of rock, scissors, and paper, data such that the correct answer is the rock (correct answer_1) is displayed as the case. In the case, the determination area for the data may be displayed in combination.

The display unit 31 may further display, based on the information (coordinate information) on the data shortage contribution for the correct answer_1, a portion having a high data shortage contribution in the image displayed as the case in a manner distinguished from other portions by methods such as highlighting display, emphasizing display, and coloring display. The portion having the high data shortage contribution may be displayed to be surrounded by a rectangular frame or an elliptical frame different from the rectangular frame indicating the determination area.

### Embodiment 3

Next, an embodiment for object detection will be described. The machine learning model 23 according to Embodiment 3 is a model in which one or more rectangles that indicate an area that is estimated to be an area in which a predetermined object exists in an image are output as prediction value candidates.

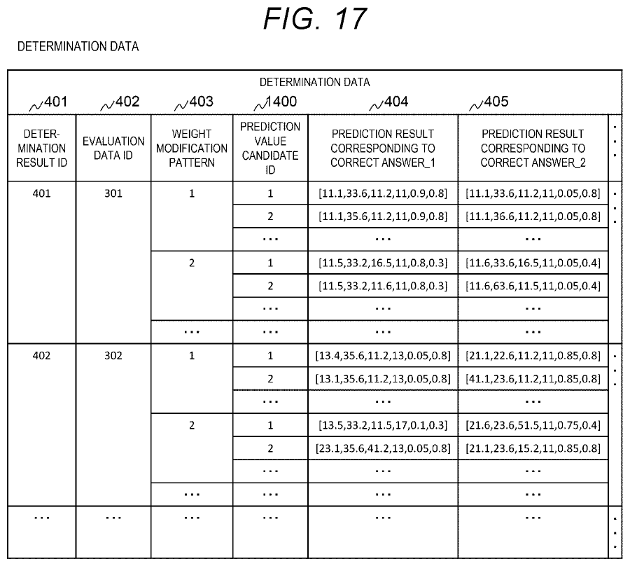

FIG. 17 is a conceptual diagram illustrating a format of the determination data 24.

The determination result ID 401, the evaluation data ID 402, the weight modification pattern 403, and the prediction results 404 and 405 corresponding to the correct answers are the same as those described above with reference to FIG. 5, and thus a detailed description thereof will be omitted. Determination data according to Embodiment 3 includes a prediction value candidate ID.

In the case of the object detection, a plurality of candidates of a prediction value may be output like a prediction value candidate (anchor). In such a case, a determination result is stored for each prediction value candidate.

The anchor is usually generated by fitting a specific template rectangle to a specific image region. The prediction value candidates may exclude some determination results in advance by non-maximum-suppression (NMS), and only the remaining determination results may be adopted as the prediction values.

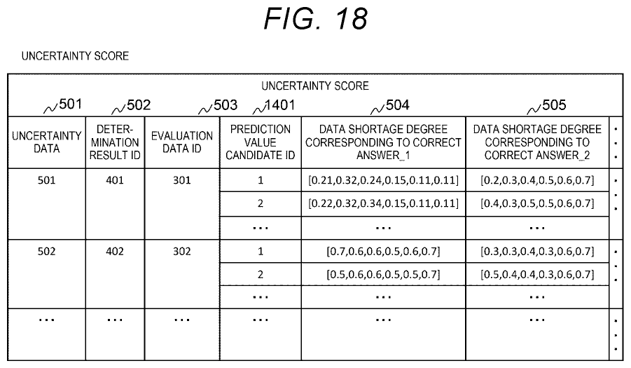

FIG. 18 is a conceptual diagram illustrating a format of the uncertainty data 25.

The uncertainty ID 501, the determination result ID 502, the evaluation data ID 503, and the data shortage degrees 504 and 505 corresponding to the correct answers are the same as those described above with reference to FIG. 6, and thus a detailed description thereof will be omitted. The uncertainty in Embodiment 3 includes the prediction value candidate ID. The prediction value candidate ID is the same as that described above with reference to FIG. 17, and thus a detailed description thereof will be omitted.

In Embodiment 3, the data shortage degree is calculated for each prediction value candidate (anchor). The data shortage degree for each final correct answer may be any of the following variations.

Variation 1: NMS is applied to a prediction calculation result, a finally remaining anchor is used as the prediction value, and the data shortage degree of the anchor is set as the data shortage degree of the correct answer.

Variation 2: An average value of the data shortage degrees of some or all anchors is set as the data shortage degree of the correct answer.

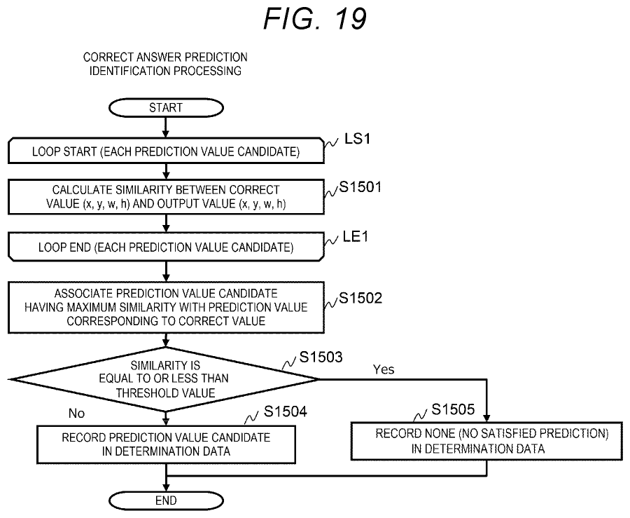

FIG. 19 is a flowchart illustrating correct answer prediction identification processing.

The correct answer prediction identification processing is a detailed example of step S901 in FIG. 10. The uncertainty calculation unit 13 performs processing of step S1501 for each prediction value candidate.

In step S1501, the uncertainty calculation unit 13 calculates a similarity between a correct value (x, y, w, h) and an output value (x, y, w, h). The output value is the prediction value. The similarity may be IoU, for example.

In step S1502, the uncertainty calculation unit 13 associates the prediction value candidate having a maximum similarity with the prediction value corresponding to the correct value. That is, the uncertainty calculation unit 13 sets, as a prediction value for the evaluation data, the prediction value candidate of the rectangle having a highest similarity to a rectangle representing the correct answer to the evaluation data.

In step S1503, the uncertainty calculation unit 13 determines whether the similarity with the associated prediction value is equal to or less than a predetermined threshold value. When the similarity is equal to or less than the threshold value (S1503: Yes), the processing proceeds to S1505. When the similarity is not equal to or less than the threshold value (S1503: No), the processing proceeds to S1504.

In step S1504, the uncertainty calculation unit 13 records the prediction value candidate in the determination data.

In step S1505, the uncertainty calculation unit 13 records none (no satisfied prediction) in the determination data.

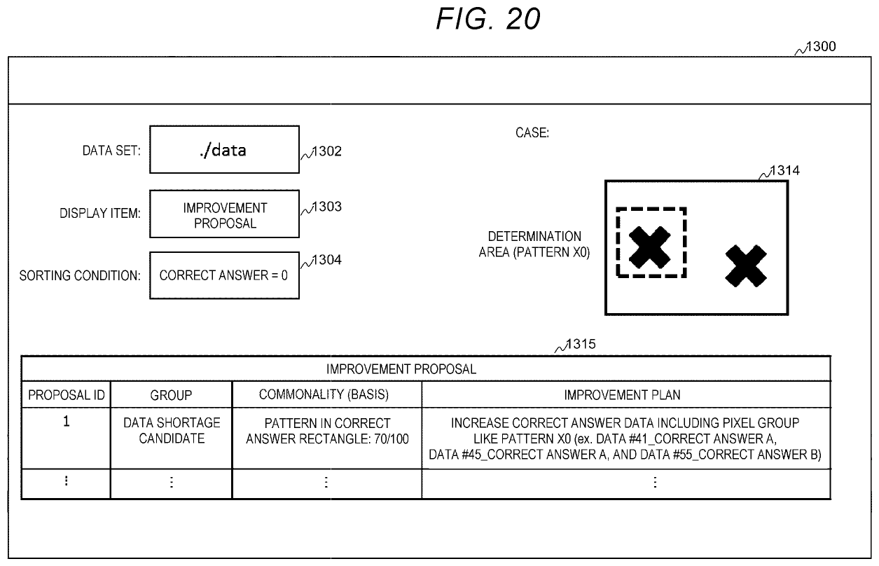

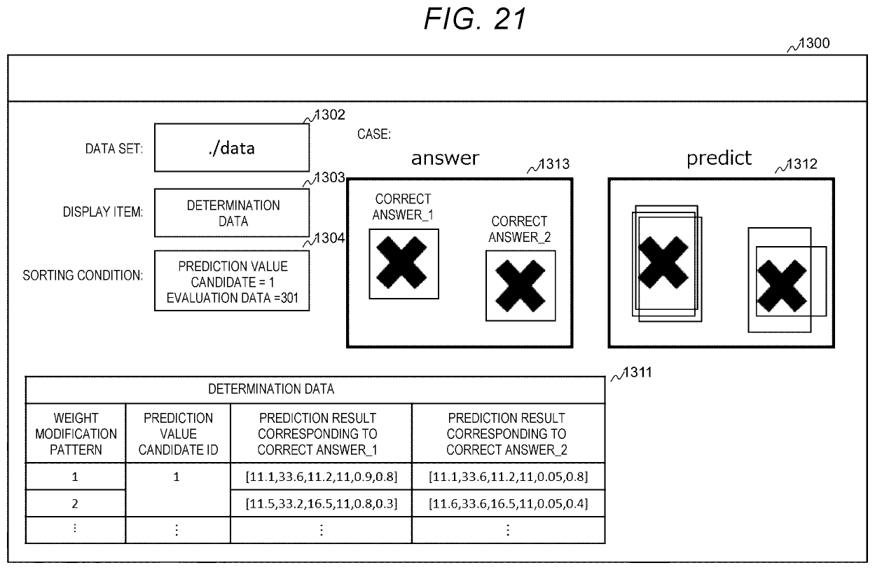

FIG. 20 is a diagram illustrating a display example on the display unit 31. FIG. 21 is a diagram illustrating a display example on the display unit 31.

The display unit 31 visualizes and displays information such as a list of improvement proposals, the number of cases, cases, determination areas, and the like based on an analysis result obtained by the tendency analysis planning unit 15 and the improvement proposal data 28, and transmits the information to a user. Hereinafter, a content displayed on the display screen 1300 of the display unit 31 will be described.

The data set 1302, the display item 1303, and the sorting condition 1304 in the display example of FIG. 20 are the same as those in FIG. 15, and thus a detailed description thereof will be omitted.

In an improvement proposal 1315, the improvement proposal information stored in the improvement proposal data 28 is displayed. In a case 1314, among the data selected by the target selection unit 14, data matching the sorting condition is displayed. In an example of FIG. 20, when solving the object detection, an image in which the object is reflected and a rectangular frame indicating a determination area corresponding to a pattern XO are displayed.

In the display example of FIG. 21, a detailed description of a part overlapping with FIG. 20 will be omitted. The display item 1303 displays the determination data. The sorting condition 1304 displays a content indicating that the prediction value candidate=1 and the evaluation data ID=301.

A content of determination data 1311 is displayed. Further, correct answer data 1313 and prediction data 1312 are displayed side by side on data that is a display target. In the correct answer data 1313, a rectangular frame surrounding an object to be detected is also displayed. In the prediction data 1312, a rectangular frame indicating the prediction result is displayed together.

The embodiments of the invention described above are examples for the purpose of explaining the present invention, and the scope of the present invention is not intended to be limited only to those embodiments. A person skilled in the art can implement the present disclosure in various other embodiments without departing from the scope of the present disclosure.

As described above, the training data evaluation system includes the uncertainty calculation unit 13, the target selection unit 14, and the tendency analysis planning unit 15. The uncertainty calculation unit 13 calculates a data shortage degree representing a training data shortage degree for each piece of evaluation data based on a prediction value obtained from the machine learning model 23 using evaluation data for evaluating a shortage of training data as an input and a correct answer for the evaluation data. The target selection unit 14 extracts target data, which is data to be added to the training data, based on a predetermined selection rule and the data shortage degree. The tendency analysis planning unit 15 specifies a tendency of the target data based on the predetermined analysis rule, and specifies a property of the training data to be added based on the tendency of the target data.

A training data evaluation method to be performed by a device having a processing device includes an uncertainty calculation step, a target selection step, and a tendency analysis planning step. In the uncertainty calculation step, a data shortage degree representing a training data shortage degree for each piece of evaluation data is calculated based on a prediction value obtained from the machine learning model 23 using evaluation data for evaluating a shortage of training data as an input and a correct answer for the evaluation data. In the target selection step, target data which is data to be added to the training data is extracted based on a predetermined selection rule and the data shortage degree. In the tendency analysis planning step, a tendency of the target data is specified based on the predetermined analysis rule, and a property of the training data to be added is specified based on the tendency of the target data.

A training data evaluation program causes a device having a processing device to implement an uncertainty calculation function, a target selection function, and a tendency analysis planning function. The uncertainty calculation function is a function of calculating a data shortage degree representing a training data shortage degree for each piece of evaluation data based on a prediction value obtained from the machine learning model 23 using evaluation data for evaluating a shortage of training data as an input and a correct answer for the evaluation data. The target selection function is a function of extracting target data, which is data to be added to the training data, based on a predetermined selection rule and the data shortage degree. The tendency analysis planning function is a function of specifying a tendency of the target data based on a predetermined analysis rule and specifying a property of the training data to be added based on the tendency of the target data.

According to the above, it is possible to effectively and efficiently add the training data by calculating the data shortage degree of the training data for each evaluation data, extracting the target data based on the predetermined selection rule and the data shortage degree, specifying the tendency of the target data based on the predetermined analysis rule, and specifying the property of the training data to be added based on the specified tendency.

The data shortage degree includes a fluctuation value representing the degree of fluctuation in the prediction value when the weight in the machine learning model 23 is modified. The selection rule is predetermined including a rule for classifying the target data based on the fluctuation value. The target selection unit 14 extracts the target data based on the selection rule and a fluctuation value. Accordingly, based on the fluctuation of the prediction value when the weight of the machine learning model is modified, the target data to which the training data is added is specified, and thus it is possible to easily add training data for an area in which the prediction value easily fluctuates.

The selection rule is predetermined including a rule for setting the data, as the target data, in which the fluctuation value is in a predetermined ratio from an upper level. Accordingly, it is possible to pick up data having a high data shortage degree and urge a user to add corresponding training data.

The machine learning model 23 is a model for detecting a predetermined object from an image. In this case, the selection rule includes a rule in which an IoU of a prediction value for the correct answer is smaller than the predetermined threshold value and the data in which the fluctuation value is in the predetermined ratio from the upper level is set as the target data. Accordingly, in the object detection, the prediction is not very accurate, and it is possible to pick up data having the high data shortage degree and urge the user to add the corresponding training data.

The machine learning model 23 is a model for identifying what appears in the image. In this case, the selection rule includes a rule for setting evaluation data, as the target data, in which the fluctuation value is greater than a predetermined threshold value. Accordingly, in the identification, it is possible to pick up data having the high data shortage degree and urge the user to add the corresponding training data.

The analysis rule is predetermined including a rule that classifies the target data into a plurality of classification groups according to the common property. The tendency analysis planning unit 15 classifies the target data into the classification groups based on the analysis rule, and specifies a property of the training data to be added for each classification group. Accordingly, the target data can be classified based on a predetermined condition, and an improvement proposal according to the classification can be presented.

The machine learning model 23 is a model for detecting the predetermined object from the image. In this case, the analysis rule is predetermined including a rule for classifying the target data in which the color variance of the object in the correct answer is greater than a predetermined threshold value into one classification group. The tendency analysis planning unit 15 proposes that an image having the color variance greater than the threshold value is to be generated based on the target data classified into the classification group and is to be added to the training data. Accordingly, it is possible to pick up the target data in which the color fluctuation is observed, and to urge the user to add the corresponding training data.

The machine learning model 23 is a model for identifying what appears in the image. In this case, the analysis rule includes a rule for classifying the target data into a target classification group based on a distribution of pixels in an image in which a contribution to a pixel fluctuation value is greater than a predetermined threshold value. The tendency analysis planning unit 15 proposes that an image having the distribution of the target classification group is to be generated from the target data classified into the target classification group based on the analysis rule and is to be added to the training data. Accordingly, in the identification, it is possible to urge the user to add the corresponding training data based on the distribution of pixels having a large influence on the data shortage degree.

The display unit 31, is further provided, which displays an improvement proposal in which a property common to the target classification group and the improvement plan to be added with the training data having the image based on the distribution of the target classification group are associated. Accordingly, the user can recognize what kind of property data is shortage and what kind of training data should be added.

The contribution is a value calculated by either one of the following equations.

$$Contribute ( c , x , {x}^{′} ) = \frac{K - 1}{{K}^{2}} ( x - {x}^{′} ) {\sum }_{k = 1}^{K} ( {IG}^{2} ( c , k , x , {x}^{′} ) - IG ( c , k , x , {x}^{′} ) * < IG ( c , k , x , {x}^{′} ) >$$

in which
x: input feature data
x′: reference feature data to be compared
K: the total number of weight modification patterns
M: the number of divisions in trapezoidal approximation of integral
P_{c,k} (x): prediction of class c for input feature data x in a model with a weight modification pattern k
∇ₓ P_{c,k} (x): partial differentiation of P_{c,k} (x) to pixel feature data x
p_{c,k}² (x): a predicted squared value of class c for the pixel feature data x in a weight modification pattern k model
∇ₓ p_{c,k}² (x): partial differentiation of p_{c,k}² (x) to the pixel feature data x

$$\begin{matrix}IG ( c , k , x , {x}^{′} ) = ( x - {x}^{′} ) {\int }_{0}^{1} {∇}_{x} {p}_{c , k} ( {x}^{′} + α ( x - {x}^{′} ) ) d α \\ \approx ( x - {x}^{′} ) \frac{{\sum }_{j = 1}^{M} {∇}_{x} {p}_{c , k} ( {x}^{′} + \frac{j}{M} ( x - {x}^{′} ) )}{M}\end{matrix} \\ \begin{matrix}IG ( c , k , x , {x}^{′} ) = ( x - {x}^{′} ) {\int }_{0}^{1} {∇}_{x} {p}_{c , k}^{2} ( {x}^{′} + α ( x - {x}^{′} ) ) d α \\ \approx ( x - {x}^{′} ) \frac{{\sum }_{j = 1}^{M} {∇}_{x} {p}_{c , k}^{2} ( {x}^{′} + \frac{j}{M} ( x - {x}^{′} ) )}{M}\end{matrix}$$

<IG(c, k, x, x′)>: an average value of IG(c, k, x, x′) obtained by a model “other than” the weight modification pattern k For example, when there are three weight modification patterns k (k=1, k=2, and k=3),

$$< IG ( c , k = 1 , x , {x}^{′} ) >= \frac{IG ( c , k = 2 , x , {x}^{′} ) + IG ( c , k = 3 , x , {x}^{′} )}{2}$$

$$\begin{matrix}Contribute ( c , x , {x}^{′} ) = ( x - {x}^{′} ) {\int }_{0}^{1} \frac{dv ( ( {x}^{′} + α ( x - {x}^{′} ) ) )}{dx} d α \\ \approx ( x - {x}^{′} ) \frac{1}{K} {\sum }_{m = 1}^{M} \frac{dv ( {x}^{′} + \frac{m}{M} ( x - {x}^{′} ) )}{dx}\end{matrix}$$

in which
x: input feature data
x′: reference feature data to be compared
K: the total number of weight modification patterns
M: the number of divisions in trapezoidal approximation of integral P_{c,k} (x): prediction of class c for input feature data x in a model with a weight modification pattern k
v(x): a variance in prediction of p_{c,k} (x)

$$\frac{dv ( x )}{dx} :$$

a partial differentiation value of v(x) to x

$$v ( x ) = {\sum }_{k = 1}^{K} {p}_{c , k} {( x )}^{2} - \frac{1}{K} {( {\sum }_{k = 1}^{K} {p}_{c , k} ( x ) )}^{2} ;$$

$$\frac{dv ( x )}{dx} = {\sum }_{k = 1}^{K} 2 {p}_{c , k} ( x ) \frac{{dp}_{c , k} ( x )}{dx} - ( {\sum }_{k = 1}^{K} \frac{2}{{K}^{2}} {p}_{c , k} ( x ) ) * {\sum }_{k = 1}^{K} \frac{{dp}_{c , k} ( x )}{dx}$$

Accordingly, it is possible to appropriately calculate the contribution to the data shortage degree and present the improvement proposal including the contribution to the user.

The machine learning model 23 is a model in which one or more rectangles that indicate an area that is estimated to be an area in which a predetermined object exists in an image are output as prediction value candidates. In this case, the uncertainty calculation unit 13 sets, as a prediction value for the evaluation data, the prediction value candidate of the rectangle having a highest similarity to a rectangle representing the correct answer to the evaluation data. Accordingly, when there are a plurality of prediction value candidates, it is possible to appropriately associate the correct answer data with the prediction value candidates.

What is claimed is:

1. A training data evaluation system comprising:
an uncertainty calculation unit configured to calculate, based on a prediction value obtained from a machine learning model using evaluation data for evaluating a shortage of training data as an input and a correct answer for the evaluation data, a data shortage degree representing a training data shortage degree for each piece of the evaluation data;
a target selection unit configured to extract target data, which is data to be added to the training data, based on a predetermined selection rule and the data shortage degree; and
a tendency analysis planning unit configured to specify a tendency of the target data based on a predetermined analysis rule and specify a property of the training data to be added based on the tendency of the target data.

2. The training data evaluation system according to claim 1, wherein
the data shortage degree includes a fluctuation value representing a degree of fluctuation in the prediction value when weight in the machine learning model is modified,
the selection rule is predetermined including a rule for classifying the target data based on the fluctuation value, and
the target selection unit extracts the target data based on the selection rule and the fluctuation value.

3. The training data evaluation system according to claim 2, wherein
the selection rule is predetermined including a rule for setting data, as the target data, in which the fluctuation value is in a predetermined ratio from an upper level.

4. The training data evaluation system according to claim 3, wherein
the machine learning model is a model for detecting a predetermined object from an image, and
the selection rule includes a rule in which an IoU of a prediction value for the correct answer is smaller than a predetermined threshold value and the data in which the fluctuation value is in the ratio from the upper level is set as the target data.

5. The training data evaluation system according to claim 2, wherein
the machine learning model is a model for identifying what appears in an image, and
the selection rule includes a rule for setting evaluation data, as the target data, in which the fluctuation value is greater than a predetermined threshold value.

6. The training data evaluation system according to claim 1, wherein
the analysis rule is predetermined including a rule for classifying the target data into a plurality of classification groups according to a common property, and
the tendency analysis planning unit classifies the target data into the classification groups based on the analysis rule, and specifies a property of the training data to be added for each classification group.

7. The training data evaluation system according to claim 6, wherein
the machine learning model is a model for detecting a predetermined object from an image,
the analysis rule is predetermined including a rule for classifying the target data in which a color variance of an object in the correct answer is greater than a predetermined threshold value into one classification group, and
the tendency analysis planning unit proposes that an image having the color variance greater than the threshold value is to be generated based on the target data classified into the classification group and is to be added to the training data.

8. The training data evaluation system according to claim 6, wherein
the machine learning model is a model for identifying what appears in an image,
the analysis rule includes a rule for classifying the target data into a target classification group based on a distribution of pixels in an image in which a contribution to a pixel fluctuation value is greater than a predetermined threshold value, and
the tendency analysis planning unit proposes that an image having the distribution of the target classification group is to be generated from the target data classified into the target classification group based on the analysis rule and is to be added to the training data.

9. The training data evaluation system according to claim 8, further comprising:
a display unit configured to display an improvement proposal in which a property common to the target classification group and an improvement plan to be added with the training data having the image based on the distribution of the target classification group are associated.

10. The training data evaluation system according to claim 8, wherein
the contribution is a value calculated by the following equation.
$$Contribute ( c , x , {x}^{′} ) = \frac{K - 1}{{K}^{2}} ( x - {x}^{′} ) {\sum }_{k = 1}^{K} ( {IG}^{2} ( c , k , x , {x}^{′} ) - IG ( c , k , x , {x}^{′} ) * < IG ( c , k , x , {x}^{′} ) >$$
in which
x: input feature data
x′: reference feature data to be compared
K: the total number of weight modification patterns
M: the number of divisions in trapezoidal approximation of integral
p_{c,k} (x): prediction of class c for input feature data x in a model with a weight modification pattern k
∇ₓ p_{c,k} (x): partial differentiation of p_{c,k} (x) to pixel feature data x
p_{c,k}² (x): a predicted squared value of class c for the pixel feature data x in a weight modification pattern k model
∇ₓ p_{c,k}² (x): partial differentiation of p_{c,k} (x) to the pixel feature data x
$$\begin{matrix}IG ( c , k , x , {x}^{′} ) = ( x - {x}^{′} ) {\int }_{0}^{1} {∇}_{x} {p}_{c , k} ( {x}^{′} + α ( x - {x}^{′} ) ) d α \\ \approx ( x - {x}^{′} ) \frac{{\sum }_{j = 1}^{M} {∇}_{x} {p}_{c , k} ( {x}^{′} + \frac{j}{M} ( x - {x}^{′} ) )}{M}\end{matrix} \\ \begin{matrix}IG ( c , k , x , {x}^{′} ) = ( x - {x}^{′} ) {\int }_{0}^{1} {∇}_{x} {p}_{c , k}^{2} ( {x}^{′} + α ( x - {x}^{′} ) ) d α \\ \approx ( x - {x}^{′} ) \frac{{\sum }_{j = 1}^{M} {∇}_{x} {p}_{c , k}^{2} ( {x}^{′} + \frac{j}{M} ( x - {x}^{′} ) )}{M}\end{matrix}$$
<IG(c, k, x, x′)>: an average value of IG(c, k, x, x′) obtained by a model “other than” the weight modification pattern k For example, when there are three weight modification patterns k (k=1, k=2, and k=3),
$$< IG ( c , k = 1 , x , {x}^{′} ) >= \frac{IG ( c , k = 2 , x , {x}^{′} ) + IG ( c , k = 3 , x , {x}^{′} )}{2}$$

11. The training data evaluation system according to claim 8, wherein
the contribution is a value calculated by the following equation.
$$\begin{matrix}Contribute ( c , x , {x}^{′} ) = ( x - {x}^{′} ) {\int }_{0}^{1} \frac{dv ( ( {x}^{′} + α ( x - {x}^{′} ) ) )}{dx} d α \\ \approx ( x - {x}^{′} ) \frac{1}{K} {\sum }_{m = 1}^{M} \frac{dv ( {x}^{′} + \frac{m}{M} ( x - {x}^{′} ) )}{dx}\end{matrix}$$
in which
x: input feature data
x′: reference feature data to be compared
K: the total number of weight modification patterns
M: the number of divisions in trapezoidal approximation of integral
p_{c,k} (x): prediction of class c for input feature data x in a model with a weight modification pattern k
v(x): a variance in prediction of p_{c,k} (x)
$$\frac{dv ( x )}{dx} :$$
a partial differentiation value of v(x) to x
$$v ( x ) = {\sum }_{k = 1}^{K} {p}_{c , k} {( x )}^{2} - \frac{1}{K} {( {\sum }_{k = 1}^{K} {p}_{c , k} ( x ) )}^{2} ;$$
$$\frac{dv ( x )}{dx} = {\sum }_{k = 1}^{K} 2 {p}_{c , k} ( x ) \frac{{dp}_{c , k} ( x )}{dx} - ( {\sum }_{k = 1}^{K} \frac{2}{{K}^{2}} {p}_{c , k} ( x ) ) * {\sum }_{k = 1}^{K} \frac{{dp}_{c , k} ( x )}{dx}$$

12. The training data evaluation system according to claim 1, wherein
the machine learning model is a model in which one or more rectangles that indicate an area that is estimated to be an area in which a predetermined object exists in an image are output as prediction value candidates,
the uncertainty calculation unit sets, as a prediction value for the evaluation data, a prediction value candidate of a rectangle having a highest similarity to a rectangle representing the correct answer to the evaluation data.

13. A training data evaluation method using a device having a processing device, comprising:
an uncertainty calculation step of calculating, based on a prediction value obtained from a machine learning model using evaluation data for evaluating a shortage of training data as an input and a correct answer for the evaluation data, a data shortage degree representing a training data shortage degree for each piece of the evaluation data;
a target selection step of extracting target data, which is data to be added to the training data, based on a predetermined selection rule and the data shortage degree; and
a tendency analysis planning step of specifying a tendency of the target data based on a predetermined analysis rule and specifying a property of the training data to be added based on the tendency of the target data.

14. A training data evaluation program that causes a device having a processing device to implement:
an uncertainty calculation function configured to calculate, based on a prediction value obtained from a machine learning model using evaluation data for evaluating a shortage of training data as an input and a correct answer for the evaluation data, a data shortage degree representing a training data shortage degree for each piece of the evaluation data;
a target selection function of extracting target data, which is data to be added to the training data, based on a predetermined selection rule and the data shortage degree; and
a tendency analysis planning function of specifying a tendency of the target data based on a predetermined analysis rule and specifying a property of the training data to be added based on the tendency of the target data.
